(19) United States
(12) Patent Application Publication
(10) Pub. No.: US 2004/0019522 A1
(43) Pub. Date: Jan. 29, 2004

(54) Multi-application smart card device software solution integrating sales tax, payment and discount rewards

(75) Inventors: Corinne Bortolin, Half Moon Bay, CA (US); Ayman Hammad, Pleasanton, CA (US); Chris S. Nelson, Foster City, CA (US); John Otaegui, Carlton (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Visa U.S.A., Inc., San Francisco, CA

(21) Appl. No.: 10/365,703

(22) Filed: Feb. 11, 2003

Related U.S. Application Data
(60) Provisional application No. 60/398,693, filed on Jul. 26, 2002.

(51) Int. Cl. G06F 17/60

(52) U.S. Cl. 705/14

(57) ABSTRACT

A system for facilitating application of discount and calculation of tax in connection with the discount is disclosed. The system includes a point-of-sale device having a discount control application. The discount control application is configured to calculate and apply the appropriate discount and calculate the appropriate tax for a transaction in accordance with the relevant tax laws where the transaction is to be conducted. Depending on the specific situation, the discount control application is capable of calculating and applying the appropriate discount in a pre-tax or post-tax manner and calculating a revised tax for the transaction, where appropriate.

### CROSS-REFERENCES TO RELATED APPLICATION(S)

The present application claims the benefit of priority under 35 U.S.C. § 119 from U.S. Provisional Patent Application Serial No. 60/398,693, entitled “MULTI-APPLICATION SMART CARD DEVICE SOFTWARE SOLUTION INTEGRATING SALES TAX, PAYMENT AND DISCOUNT REWARDS”, filed on Jul. 26, 2002, the disclosure of which is hereby incorporated by reference in its entirety for all purposes.

### BACKGROUND OF THE INVENTION

The present invention generally relates to discounts that are to be applied to commercial transactions. More specifically, the present invention relates to a method and system for selectively applying discounts to commercial transactions based on relevant tax laws.

In commercial transactions, discounts are often given in a variety of situations. For example, discounts may be given during a sales event or discounts may be offered to customers participating in a loyalty program. The application of a discount has certain legal ramifications. This is because the application of a discount to a purchase or commercial transaction must follow tax laws that are unique to each state in the United States. These laws govern the respective applicability of pre-tax and post-tax discounts that are dependent upon the sponsoring institution and/or limits on the merchandise that may be discounted.

In conventional systems, the total transaction amount and the discount amount for a transaction are calculated separately. More specifically, the electronic cash register is used to calculate the total transaction amount based on the total of purchase and tax amounts. This total transaction amount is then entered into a merchant's stand-alone point of sale (POS) device. The POS device is responsible for calculating the discount amount. Since the POS device does not interface with the electronic cash register, the POS device can only apply any applicable discount to the total transaction amount that was entered. This may pose a problem in some states. This is because different states have their own respective tax laws governing how the discount amount is to be calculated. The practice of using the total transaction amount to calculate the discount amount may be prohibited in some states. One reason is that the calculated discount amount can be improperly inflated due to the inclusion of the tax amount in the total transaction amount.

Hence it would be desirable to provide a method and system that is capable of selectively applying discounts to commercial transactions based on relevant tax laws.

### BRIEF SUMMARY OF THE INVENTION

A system for facilitating application of discount and calculation of tax in connection with the discount is disclosed. In an exemplary embodiment, the system includes a point-of-sale device having a discount control application. The discount control application is configured to calculate and apply the appropriate discount and calculate the appropriate tax for a transaction in accordance with the relevant tax laws where the transaction is to be conducted. Depending on the specific situation, the discount control application is capable of calculating and applying the appropriate discount in a pre-tax or post-tax manner and calculating a revised tax for the transaction, where appropriate.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified block diagram illustrating an exemplary embodiment of the present invention;

FIG. 2 is a simplified functional block diagram illustrating operation of an exemplary embodiment of the present invention where the discount amount is calculated based on the total transaction amount including tax;

FIG. 3 is a simplified functional block diagram illustrating operation of an exemplary embodiment of the present invention where the discount amount is calculated based on a pre-tax sub-total of the total transaction amount;

FIG. 4 is a simplified functional block diagram illustrating operation of another exemplary embodiment of the present invention where the discount amount is calculated based on the pre-tax sub-total of the total transaction amount;

FIG. 5 is a simplified functional block diagram illustrating operation of an exemplary embodiment of the present invention where the discount amount and the tax amount are calculated separately by different applications in a POS device; and

FIG. 6 is a simplified functional block diagram illustrating operation of an exemplary embodiment of the present invention where the discount amount and the tax amount are calculated by an electronic cash register in cooperation with a POS device.

### DETAILED DESCRIPTION OF THE INVENTION

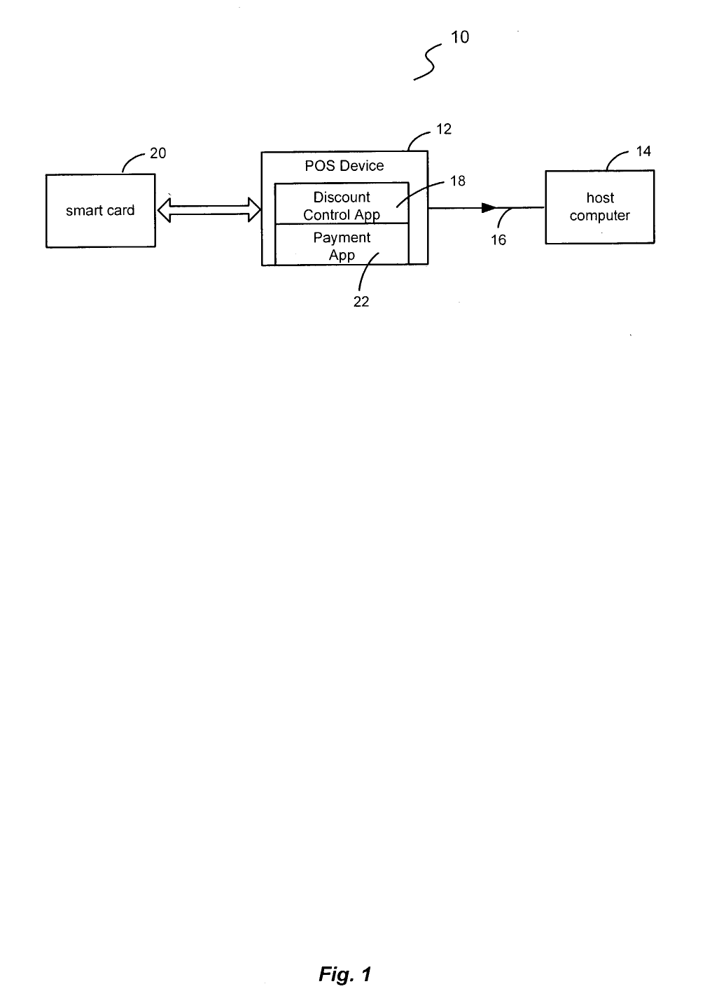

The present invention in one or more exemplary embodiments will now be described. FIG. 1 is a simplified block diagram illustrating an exemplary embodiment of the present invention. This exemplary embodiment is a system 10 that includes a point-of-sale (POS) device 12 and a host computer 14. The POS device 12 and the host computer 14 may be connected to each other via a communication link 16. The communication link 16 includes a dialup connection, a dedicated connection such as a leased line, a computer network and the like.

The POS device 12 further includes a discount control application 18. In one exemplary implementation, the discount control application 18 is implemented as control logic and/or modules using computer software. As will be further described below, the discount control application 18 directs the POS device 12 to calculate the appropriate discount and/or tax amounts for a pending transaction based on the relevant tax laws.

The POS device 12 also includes other components and/or applications (not shown) that may be needed to facilitate completion of transactions. For example, the POS device 12 may include a reward control application (not shown). The reward control application may be used to calculate rewards resulted from a pending transaction in connection with a loyalty program and allow a participant in the loyalty program to accept or defer redemption of available rewards. An exemplary example of a POS device 12 having the reward control application can be found in a co-pending, commonly owned U.S. patent application entitled “MULTI-APPLICATION SMART CARD DEVICE SOFTWARE SOLUTION FOR SMART CARDHOLDER REWARD SELECTION AND REDEMPTION”, filed concurrently herewith, the disclosure of which is hereby incorporated by reference (Attorney Docket No. 16222U-011610US). The reward control application may cooperate with the discount control application 18. For example, the reward control application may identify the reward that has been selected for redemption and relay such information to the discount control application 18 to allow the appropriate discount amount to be calculated.

The POS device 12 may also include a payment application 22 that facilitates payment for a transaction. Where appropriate, the discount control application 18 interacts with these other components and/or applications to properly calculate the appropriate discount and/or tax amounts.

It should be realized by a person of ordinary skill in the art that the components and/or applications included in the POS device 12 may be implemented in a modular or integrated manner. In other words, the respective functionality of these components and/or applications may be implemented and distributed amongst one or more modules within the POS device 12.

In one exemplary embodiment, the discount control application 18 operates in a standalone or offline manner. In other words, the discount control application 18 by itself is able to handle discount and tax amount calculation. Statistics and other accounting and historical information is periodically transmitted from the POS device 12 to the host computer 14 via the communication link 16 for settlement and accounting purposes. However, it should be understood that, alternatively, the discount control application 18 may also function in cooperation with another application to handle discount and tax amount calculation.

The discount control application 18 in the POS device 12 may be configured or programmed to first determine if a discount is applicable for a transaction and then apply the appropriate discount and/or calculate the appropriate tax amount in various different manners depending on the respective tax laws of the states where the transactions are to be conducted. For example, in some situations, state laws may prohibit discounts on tobacco and/or alcohol products when such discounts are based on participation in a loyalty program. As shown in FIG. 1, the appropriate discount control application 18 can be uploaded to the POS device 12 by the host computer 14 via the communication link 16. The discount control application 18 operates in the following exemplary manners. In one exemplary embodiment, the discount control application 18 cooperates with the reward control application. The POS device 12 is equipped to function in cooperation with a smartcard 20. The smartcard 20 includes one or more applications. One of these applications includes, for example, a loyalty application that relates to a loyalty program of which the smartcard-holder is a participant. The loyalty application may include information relating to the loyalty program and the smartcard-holder. The applications and information stored in the smartcard 20 are used by the reward control application to facilitate reward redemption. The reward control application is used to identify the reward that has been selected for redemption and relay such information to the discount control application 18. The discount control application 18 then calculates the appropriate discount amount accordingly depending on the relevant tax laws.

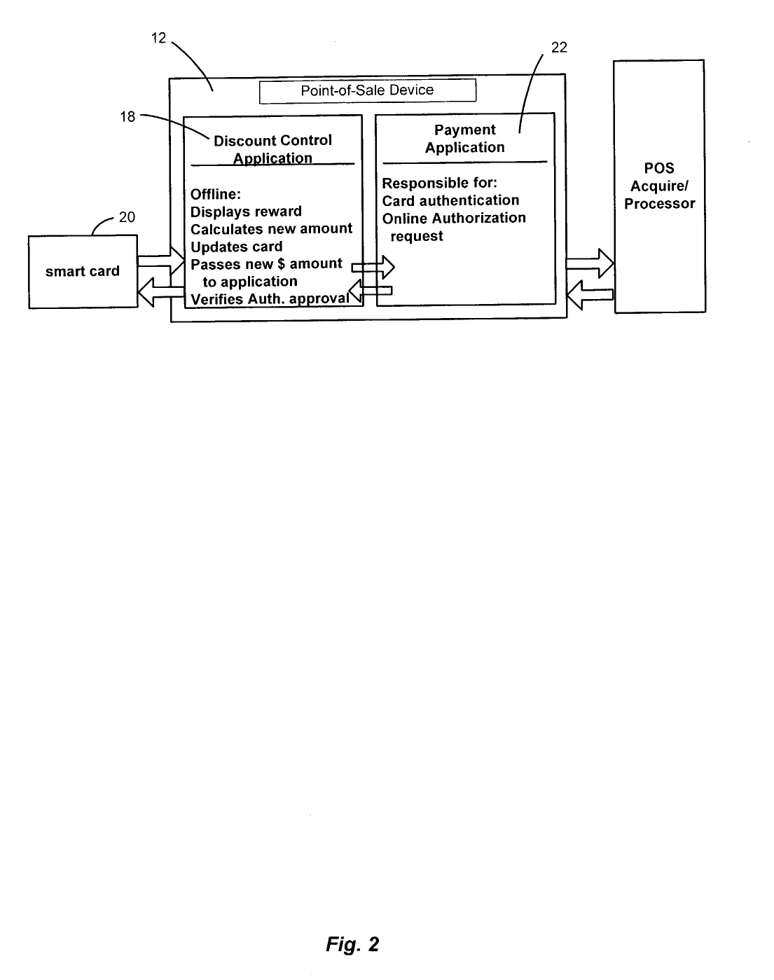

FIG. 2 illustrates an exemplary situation where the discount amount is calculated based on the total transaction amount including tax. In this situation, the discount control application 18 is configured to calculate the appropriate discount amount using the total transaction amount including tax. In other words, the discount amount is calculated post-tax. More specifically, the discount control application 18 receives reward or discount information from the reward control application. The total transaction amount including tax is also received by the discount control application 18. In one exemplary embodiment, the total transaction amount, which has been calculated separately by an electronic cash register, is manually entered into the POS device 12 by a store clerk. The discount control application 18 then uses the total transaction amount and the received discount information to calculate the discount amount for the transaction. Once the discount amount is calculated, the discount control application 18 passes the discount amount, as well as other relevant information, to the payment application 22 to facilitate completion of payment for the transaction. In addition, the discount control application 18 also updates the smartcard 20 with the relevant information for the transaction.

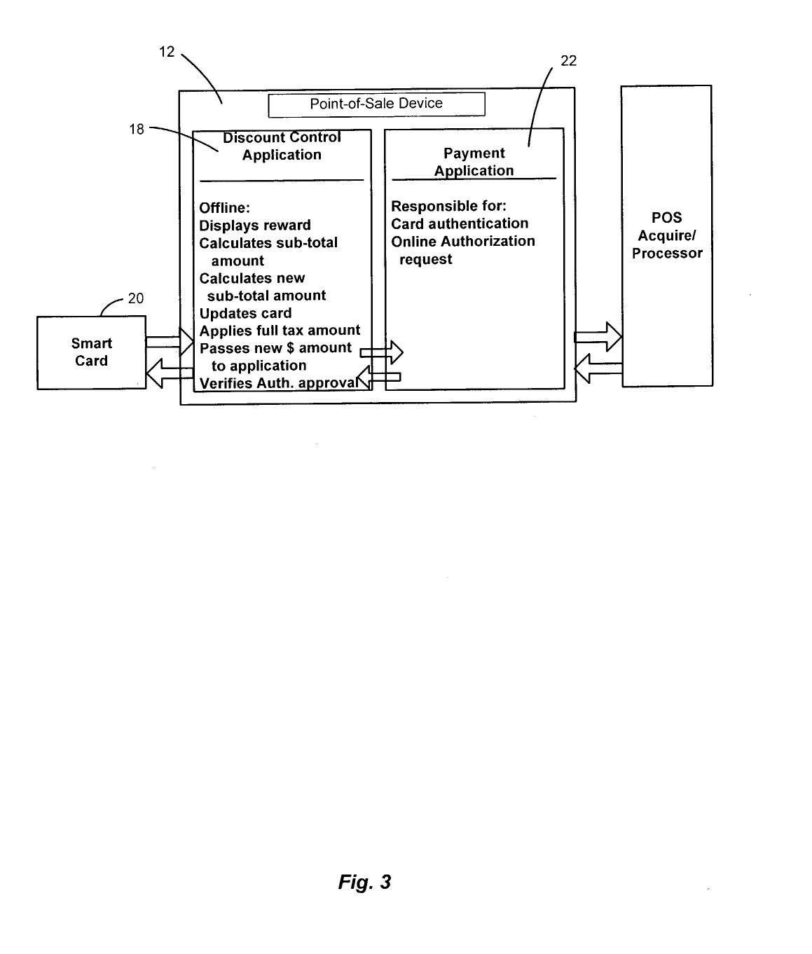

FIG. 3 illustrates one exemplary situation where the discount amount is calculated based on a pre-tax sub-total of the total transaction amount. In this situation, the discount amount is calculated pre-tax. This situation differs from that described in connection with FIG. 2 above in that the total transaction amount is broken down into the pre-tax sub-total and the tax amount first. The pre-tax sub-total and the tax amount are then provided to the discount control application 18. In one exemplary embodiment, the pre-tax sub-total and the tax amount are entered manually to the POS device 12 by a store clerk. Similarly, the discount control application 18 also receives reward or discount information from the reward control application.

The discount control application 18 then uses the discount information and the pre-tax sub-total to calculate the discount amount. That is, the discount is applied only to the pre-tax sub-total. The new pre-tax sub-total is then obtained by subtracting the discount amount from the original pre-tax sub-total. The tax amount is not changed by the discount control application 18. All the relevant information is then passed to the payment application 22 to facilitate completion of payment for the transaction. The relevant information is also passed to the smartcard 20 for update purposes.

By performing the foregoing, the smartcard-holder would pay full tax amount on the original pre-tax sub-total before the discount is applied and the discount is applied only to the pre-tax sub-total. By providing the original pre-tax sub-total and the tax amount separately to the POS device 12, a receipt can be provided reporting the original pre-tax sub-total, the discount and the tax amount, all of which are added separately on the receipt.

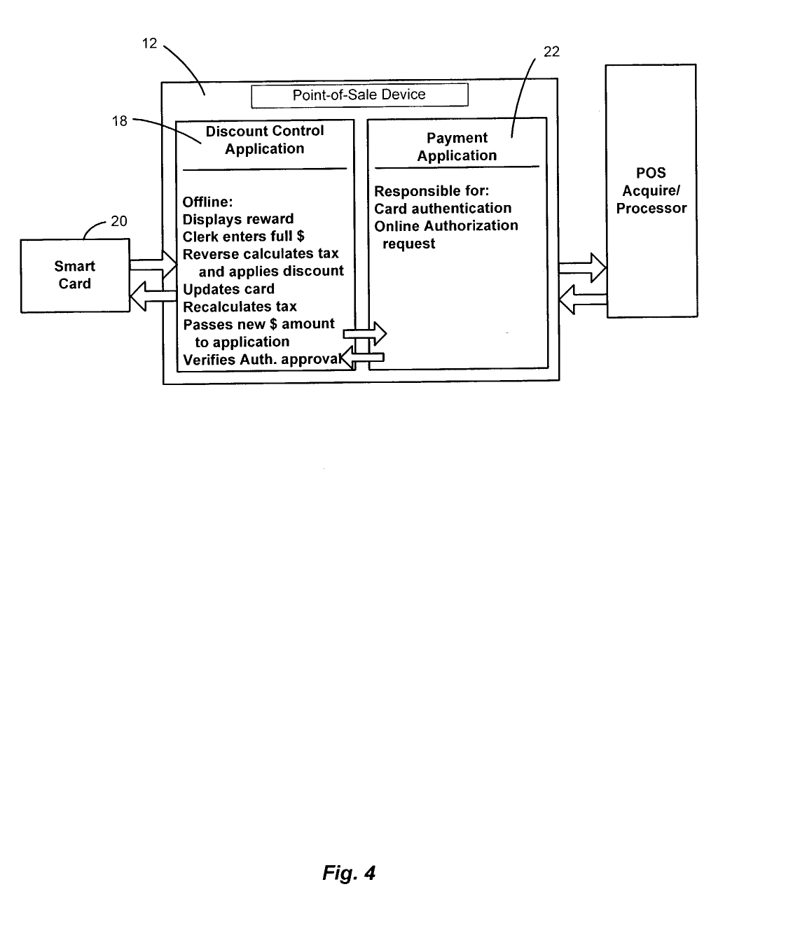

FIG. 4 illustrates another exemplary situation where the discount amount is calculated based on the pre-tax sub-total of the total transaction amount. In this situation, the discount control application 18 is configured to first derive the pre-tax sub-total from the total transaction amount and then calculate the appropriate discount amount using the pre-tax sub-total. More specifically, the discount control application 18 receives reward or discount information from the reward control application. The total transaction amount including tax is also received by the discount control application 18. In one exemplary embodiment, the total transaction amount, which has been calculated separately by an electronic cash register, is manually entered into the POS device 12 by a store clerk.

The discount control application 18 then uses the total transaction amount to reverse calculate the tax amount included in the total transaction amount. To facilitate calculation of the tax amount, the discount control application 18 has access to the relevant tax rate information. Preferably, the relevant tax rate information is stored on the POS device 12. Once the tax amount is calculated, the discount control application 18 is able to calculate the pre-tax sub-total of the total transaction amount.

The pre-tax sub-total is calculated by subtracting the tax amount from the total transaction amount. Then, using the received discount information and the pre-tax sub-total, the discount control application 18 calculates the discount amount for the transaction. The discount amount is then applied to the pre-tax sub-total by the discount control application 18 to arrive at a discounted pre-tax sub-total. The discount control application 18 then calculates the new tax amount using the discounted pre-tax sub-total and the relevant tax rate information. All the relevant information is then passed by the discount control application 18 to the payment application 22 to facilitate completion of payment for the transaction.

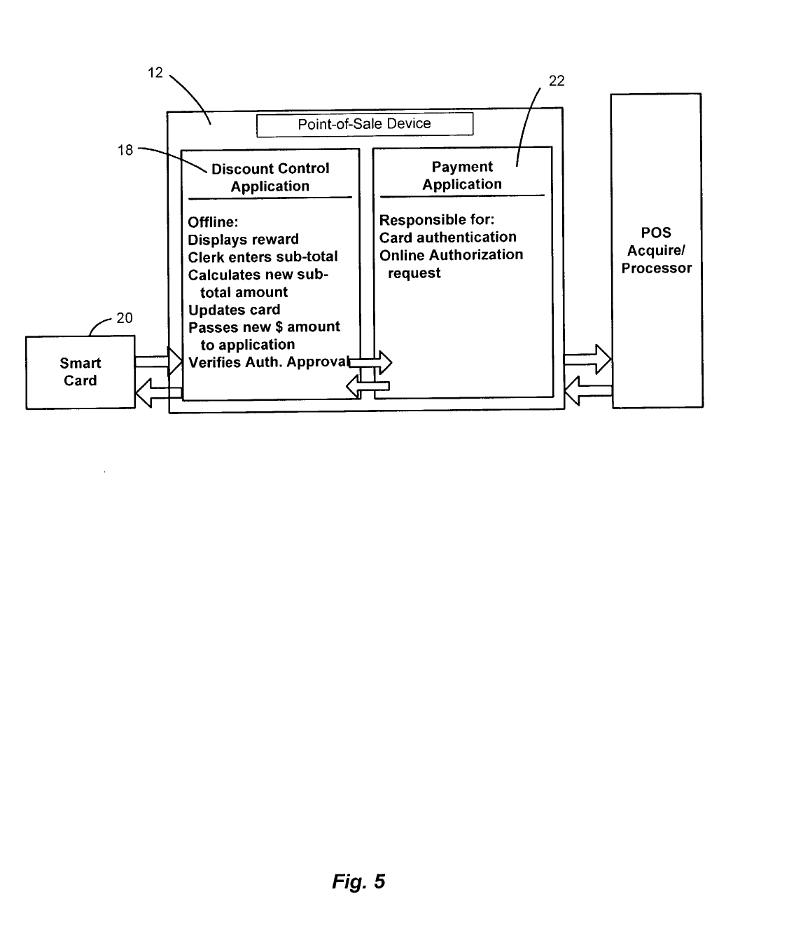

FIG. 5 illustrates an exemplary situation where the discount amount and the tax amount are calculated separately by different applications in the POS device 12. In this situation, the pre-tax sub-total is provided to the discount control application 18. Again, in one exemplary embodiment, the pre-tax sub-total is entered into the POS device 12 by a store clerk. Reward or discount information is also provided to the discount control application 18 by the reward control application. Using the discount information and the pre-tax sub-total, the discount control application 18 calculates the new pre-tax sub-total. That is, the appropriate discount is applied to the original pre-tax sub-total. Next, the discount control application 18 passes the new pre-tax sub-total to the payment application 22. The payment application 22 then calculates the appropriate tax amount based on the new pre-tax sub-total and completes the transaction.

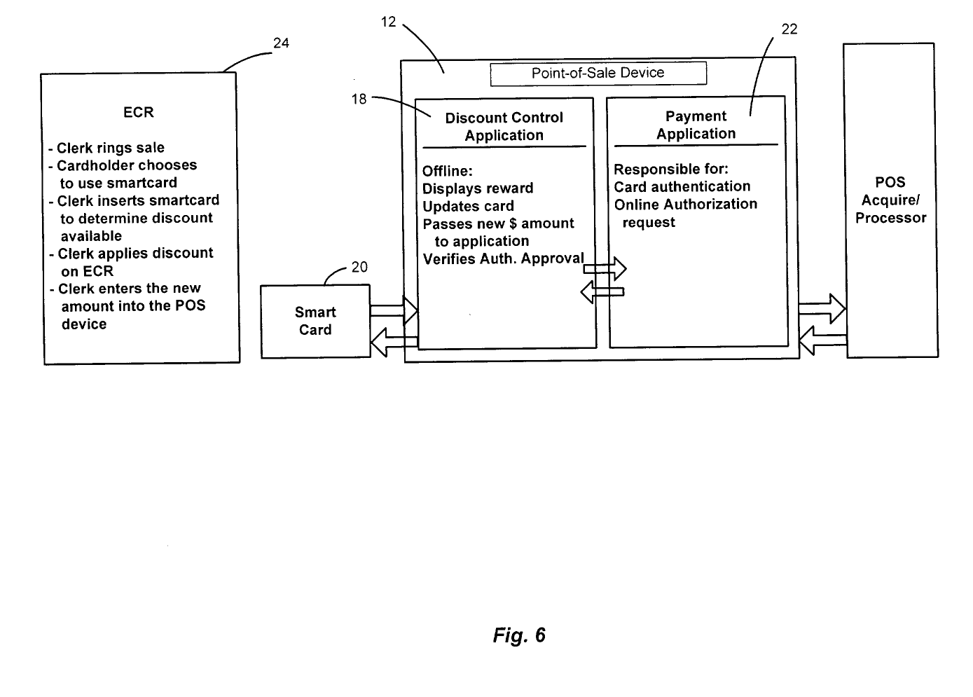

FIG. 6 illustrates an exemplary situation where the discount amount and the tax amount are calculated by an electronic cash register 24 in cooperation with the POS device 12. In this situation, the smartcard 20 is inserted into the POS device 12 for purposes of retrieving reward or discount information. More specifically, the smartcard-holder is given a choice to select a reward or discount that is available for the transaction. Once the discount is selected, the selected discount is used by the electronic cash register 24 to generate a pre-tax sub-total. In one exemplary implementation, information relating to the selected discount is passed to the electronic cash register 24 by the POS device 12; alternatively, such information can be entered into the electronic cash register 24 by a store clerk. A pre-tax sub-total is then calculated based on the selected discount. The appropriate tax amount is also calculated by the electronic cash register 24 based on the pre-tax sub-total. The pre-tax sub-total and the tax amount are then passed from the electronic cash register 24 to the POS device 12 to complete the transaction. Furthermore, the smartcard 20 is updated by the reward control application to reflect the discount that has been selected and redeemed.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention including using hardware and a combination of hardware and software.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A device for calculating transaction amounts for transactions, comprising:
a discount control application configured to receive a total transaction amount and reward information relating to a transaction and calculate a discount amount for the transaction using the total transaction amount and the reward information, the discount control application further configured to calculate a revised total transaction amount using the discount amount; and
a payment application configured to receive the revised total transaction amount and facilitate payment for the transaction using the revised total transaction amount.

2. The device of claim 1 wherein the discount amount is calculated on either a post-tax basis or a pre-tax basis.

3. The device of claim 2 wherein which basis is used to calculate the discount amount depends on where the transaction is incurred.

4. The device of claim 2 wherein when the discount amount is calculated on the post-tax basis, the discount amount is calculated using the total transaction amount including tax.

5. The device of claim 2 wherein when the discount amount is calculated on the pre-tax basis, the discount amount is calculated using a pre-tax sub-total; and
wherein the pre-tax sub-total is the total transaction amount less a tax amount for the transaction.

6. The device of claim 5 wherein the discount control application is further configured to calculate the tax amount using the total transaction amount and a tax rate.

7. The device of claim 5 wherein the revised total transaction amount comprises a revised pre-tax sub-total and the tax amount; and
wherein the revise pre-tax sub-total is calculated by subtracting the discount amount from the pre-tax sub-total.

8. The device of claim 5 wherein the discount control application is further configured to calculate a revised tax amount for the transaction; and
wherein the revised tax amount is based on the pre-tax sub-total less the discount amount.

9. The device of claim 7 wherein the revised total transaction amount comprises a revised pre-tax sub-total and the revised tax amount; and
wherein the revised pre-tax sub-total is calculated by subtracting the discount amount from the pre-tax sub-total.

10. The device of claim 1 wherein the device is a point-of-sale device or an electronic cash register.

11. The device of claim 1 wherein the discount control application is further configured to determine whether the transaction is entitled to receive the discount amount.

12. The device of claim 1 wherein the discount control application and the payment application are implemented using software, hardware or a combination of both.

13. A device for calculating transaction amounts for transactions, comprising:
a first application configured to calculate a discount amount for a transaction using reward information and a total transaction amount comprising a pre-tax sub-total and a tax amount, the first application further configured to calculate a revised total transaction amount using the discount amount; and
a second application configured to facilitate payment of the transaction using the revised total transaction amount.

14. The device of claim 13 further comprising:
a third application configured to derive the reward information using loyalty program information provided by a loyalty program participant.

15. The device of claim 13 wherein the discount amount is calculated on either a post-tax basis or a pre-tax basis.

16. The device of claim 15 wherein which basis is used to calculate the discount amount depends on where the transaction is incurred.

17. The device of claim 15 wherein when the discount amount is calculated on the post-tax basis, the discount amount is calculated using the total transaction amount including the pre-tax sub-total and the tax amount.

18. The device of claim 15 wherein when the discount amount is calculated on the pre-tax basis, the discount amount is calculated using the pre-tax sub-total.

19. The device of claim 13 wherein the revised total transaction amount comprises a revised pre-tax sub-total and the tax amount; and
wherein the revised pre-tax sub-total is calculated by subtracting the discount amount from the pre-tax sub-total.

20. The device of claim 13 wherein the first application is further configured to calculate a revised tax amount for the transaction; and
wherein the revised tax amount is based on the pre-tax sub-total less the discount amount.

21. The device of claim 19 wherein the revised total transaction amount comprises a revised pre-tax sub-total and the revised tax amount; and
wherein the revised pre-tax sub-total is calculated by subtracting the discount amount from the pre-tax sub-total.

22. The device of claim 13 wherein the first application is further configured to calculate the pre-tax sub-total and the tax amount from the total transaction amount by using a tax rate.

23. The device of claim 13 wherein the first application is further configured to determine whether the transaction is entitled to receive the discount amount.

24. The device of claim 13 wherein the device is a point-of-sale device or an electronic cash register.

25. The device of claim 13 wherein the first application and the second application are implemented using software, hardware or a combination of both.

26. A system for calculating transaction amounts for transactions, comprising:
a smartcard having stored thereon loyalty program information relating to a loyalty program participant; and
a point-of-sale device comprising:
a first application configured to retrieve the loyalty program information from the smartcard and generate reward information for a transaction based on the loyalty program information and a reward selection made by the loyalty program participant;
a second application configured to calculate a discount amount for the transaction using the reward information and a total transaction amount comprising a pre-tax sub-total and a tax amount, the second application further configured to calculate a revised total transaction amount using the discount amount; and
a third application configured to facilitate payment of the transaction using the revised total transaction amount.

27. The system of claim 26 further comprising:
an electronic cash register configured to provide the total transaction amount to the point-of-sale device.

28. The system of claim 26 wherein the discount amount is calculated on either a post-tax basis or a pre-tax basis.

29. The system of claim 28 wherein which basis is used to calculate the discount amount depends on where the transaction is incurred.

30. The system of claim 28 wherein when the discount amount is calculated on the post-tax basis, the discount amount is calculated using the total transaction amount including the pre-tax sub-total and the tax amount.

31. The system of claim 28 wherein when the discount amount is calculated on the pre-tax basis, the discount amount is calculated using the pre-tax sub-total.

32. The system of claim 26 wherein the revised total transaction amount comprises a revised pre-tax sub-total and the tax amount; and
wherein the revised pre-tax sub-total is calculated by subtracting the discount amount from the pre-tax sub-total.

33. The system of claim 26 wherein the second application is further configured to calculate a revised tax amount for the transaction; and
wherein the revised tax amount is based on the pre-tax sub-total less the discount amount.

34. The system of claim 33 wherein the revised total transaction amount comprises a revised pre-tax sub-total and the revised tax amount; and
wherein the revised pre-tax sub-total is calculated by subtracting the discount amount from the pre-tax sub-total.

35. The system of claim 26 wherein the second application is further configured to calculate the pre-tax sub-total and the tax amount from the total transaction amount by using a tax rate.

36. The system of claim 26 wherein the second application is further configured to determine whether the discount amount is applicable to the transaction.

37. The system of claim 26 wherein the first application is further configured to update the loyalty program information stored on the smartcard upon completion of payment for the transaction.

38. The system of claim 26 wherein the first application, the second application and the third application are implemented using software, hardware or a combination of both.

39. A method for calculating transaction amounts for transactions, comprising:
providing reward information and a total transaction amount for a transaction to a point-of-sale device;
directing the point-of-sale device to calculate a discount amount for the transaction based on the reward information and the total transaction amount; and
directing the point-of-sale device to calculate a revised total transaction amount based on the discount amount.

40. The method of claim 39 further comprising:
directing the point-of-sale device to facilitate payment for the transaction using the revised total transaction amount.

41. The method of claim 39 wherein the discount amount is calculated on either a post-tax basis and a pre-tax basis.

42. The method of claim 41 wherein which basis is used to calculate the discount amount depends on where the transaction is incurred.

43. The method of claim 41 wherein when the discount amount is calculated on the pre-tax basis, the discount amount is calculated using a pre-tax sub-total; and
wherein the pre-tax sub-total is the total transaction amount less a tax amount for the transaction.

44. The method of claim 43 wherein the revised total transaction amount comprises a revised pre-tax sub-total and the tax amount; and
wherein the revised pre-tax sub-total is calculated by subtracting the discount amount from the pre-tax sub-total.

45. The method of claim 43 further comprising:
directing the point-of-sale device to calculate the tax amount using the total transaction amount and a tax rate.

46. The method of claim 43 further comprising:
directing the point-of-sale device to calculate a revised tax amount based on the pre-tax sub-total less the discount amount.

47. The method of claim 46 wherein the revised total transaction amount comprises a revised pre-tax sub-total and the revised tax amount; and
wherein the revised pre-tax sub-total is calculated by subtracting the discount amount from the pre-tax sub-total.

48. The method of claim 39 further comprising:
directing the point-of-sale device to determine whether the discount amount is applicable to the transaction.

49. A method for calculating transaction amounts for transactions, comprising:
retrieving loyalty program information and a reward selection from a loyalty program participant;
deriving reward information for a transaction using the loyalty program information and the reward selection;
forwarding the reward information and a total transaction amount for the transaction to a point-of-sale device, the total transaction amount including a pre-tax sub-total and a tax amount;
directing the point-of-sale device to calculate a discount amount for the transaction based on the reward information and the total transaction amount; and
directing the point-of-sale device to calculate a revised total transaction amount based on the discount amount.

50. The method of claim 49 further comprising:
directing the point-of-sale device to facilitate payment for the transaction using the revised total transaction amount.

51. The method of claim 50 wherein the loyalty program information is stored on a smartcard and the method further comprises:
updating the loyalty program information on the smartcard upon completion of payment for the transaction.

52. The method of claim 49 wherein the discount amount is calculated on either a post-tax basis and a pre-tax basis.

53. The method of claim 52 wherein which basis is used to calculate the discount amount depends on where the transaction is incurred.

54. The method of claim 52 wherein when the discount amount is calculated on the pre-tax basis, the discount amount is calculated using the pre-tax sub-total.

55. The method of claim 49 wherein the revised total transaction amount comprises a revised pre-tax sub-total and the tax amount; and
wherein the revised pre-tax sub-total is calculated by subtracting the discount amount from the pre-tax sub-total.

56. The method of claim 49 further comprising:
directing the point-of-sale device to calculate the tax amount using the total transaction amount and a tax rate.

57. The method of claim 49 further comprising:
directing the point-of-sale device to calculate a revised tax amount based on the pre-tax sub-total less the discount amount.

58. The method of claim 57 wherein the revised total transaction amount comprises a revised pre-tax sub-total and the revised tax amount; and
wherein the revised pre-tax sub-total is calculated by subtracting the discount amount from the pre-tax sub-total.

59. The method of claim 49 further comprising:
directing the point-of-sale device to determine whether the discount amount is applicable to the transaction.
